(19) United States
(12) Patent Application Publication
(10) Pub. No.: US 2014/0060494 A1
(43) Pub. Date: Mar. 6, 2014

(54) On-Vehicle Compressed Natural Gas System With In-Cabin Display

(71) Applicant: dHybrid Systems, LLC, Saint George, UT (US)

(72) Inventors: Trevor Milton, Santa Clara, UT (US); Morgan Mackelprang, Cedar City, UT (US); Isaac Sloan, Saint George, UT (US)

(73) Assignee: dHybrid Systems, LLC, Saint George, UT (US)

(21) Appl. No.: 14/076,891

(22) Filed: Nov. 11, 2013

(51) Int. Cl. F02D 41/30

(52) U.S. Cl. CPC F02D 41/3005
USPC 123/478

(57) ABSTRACT

A compressed natural gas (CNG) fueling system includes a CNG reservoir that can be mounted to a vehicle, a sensor arrangement that can sense an environmental condition in a vicinity of the vehicle and a condition associated with the reservoir, an electronically configurable display that can be mounted within a cabin of the vehicle, and an electronic control unit (ECU) operatively arranged with the sensor arrangement and display. The ECU generates output for the display based on the sensed conditions to provide information about the CNG fueling system.

### TECHNICAL FIELD

This disclosure relates to in-cabin displays for on-vehicle compressed natural gas systems.

### BACKGROUND

Compressed natural gas (CNG) may be used as a fuel for certain vehicles. Certain of these vehicles may be retrofit with a CNG system so that the vehicle can run on CNG. As such, gauges provided within the vehicle by the original equipment manufacturer may not be configured to convey information about the CNG system.

### SUMMARY

A compressed natural gas (CNG) fueling system includes a CNG reservoir configured to be mounted to a vehicle, a sensor arrangement configured to sense an environmental condition in a vicinity of the vehicle and a condition associated with the reservoir, an electronically configurable display configured to be mounted within a cabin of the vehicle, and an electronic control unit operatively arranged with the sensor arrangement and display. The electronic control unit is configured to generate output for the display based on the sensed conditions to provide information about the CNG fueling system.

### BRIEF DESCRIPTION OF THE DRAWINGS

FIG. 1 is a block diagram of a vehicle (e.g., commercial truck) retrofit with a compressed natural gas (CNG) system.

FIGS. 2 through 4 are schematic diagrams of displays for the CNG system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

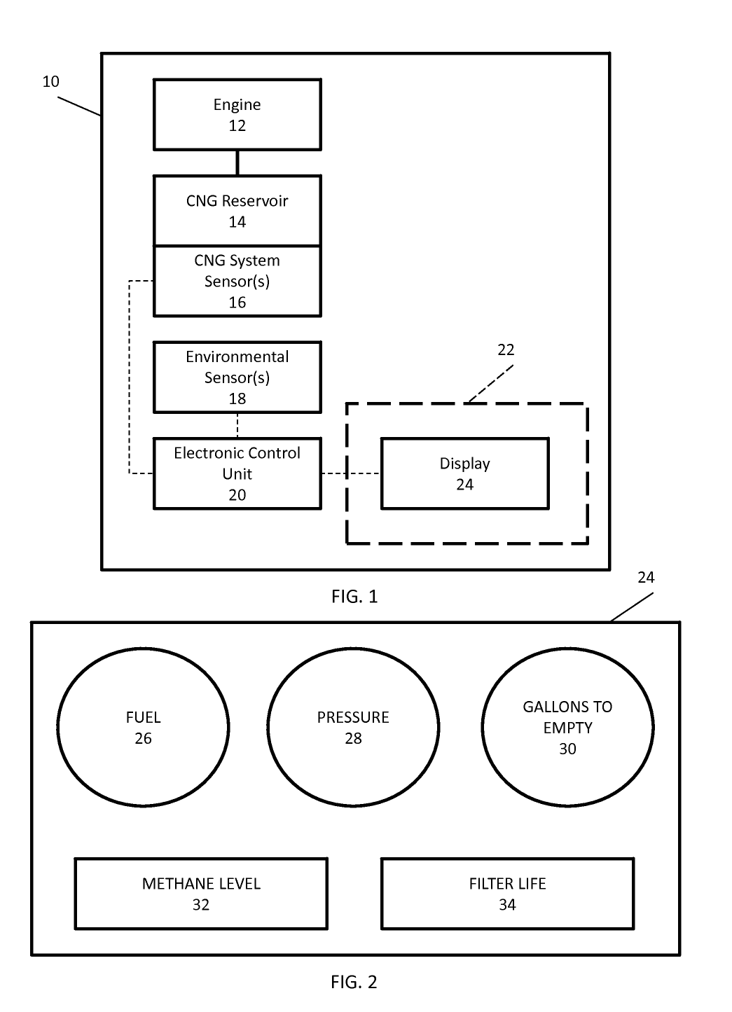

Referring to FIG. 1, a vehicle 10 includes an engine 12, compressed natural gas (CNG) reservoir 14 (e.g., one or more tanks), CNG system sensors 16 (e.g., temperature sensor, regulator sensor, high pressure sensor, low pressure sensor, CNG system access panel sensor, methane sensor, etc.), environmental sensors 18 (e.g., altitude sensor, temperature sensor, global positioning sensor, etc.), electronic control unit 20, cabin 22, and display 24 disposed within the cabin 22. Representative relationships among the components are illustrated. Physical placement and orientation may vary.

CNG stored within the reservoir 14 is delivered to the engine 12 via tubing including a filter and regulator as represented by solid line. The engine 12 consumes the CNG to generate motive power for the vehicle 10.

The CNG system sensors 16 are arranged as known in the art to detect various conditions or properties associated with the CNG system. These sensors, as suggested above, may include a temperature sensor to sense a temperature of the CNG, a regulator sensor to sense operating parameters associated with the regulator, a high pressure sensor to sense pressures associated with the CNG that are greater than a particular threshold pressure, a low pressure sensor to sense pressures associated with the CNG that are less than the threshold pressure, an access panel sensor to detect whether an access panel for the CNG system is open, and a methane sensor to sense methane levels in the vicinity of the CNG system, such as in the cabin 22. Other and/or different sensors may also be used.

The environmental sensors 18 are also arranged as known in the art to detect various conditions in the vicinity of the vehicle 10. These sensors may include an altitude sensor, an ambient temperature sensor, a global positioning sensor, etc.

The sensors 16, 18 are in communication with electronic control unit 20 as represented by dashed line. This communication may be facilitated via wireless or wired transmissions. The sensors 16, 18 and electronic control unit 20, for example, may have access to a communication network provided within the vehicle 10. Data collected by the sensors 16, 18 may be communicated to this network and then subsequently read by the electronic control unit 20. Alternatively, data collected by the sensors 16, 18 may be wirelessly transmitted for reception by the electronic control unit 20. And, the electronic control unit 20 may wirelessly transmit data off-board the vehicle 10. In such examples, the box representing the electronic control unit 20 also represents a wireless transceiver, which may or may not be physically integrated with the electronic control unit 20. Other scenarios are also contemplated. Moreover, the electronic control unit 20 may be programmed to read fault or status indicators present on the network.

The display 24 (e.g., a flat-panel electronically configurable touchscreen, graphical user interface, etc.) is mounted within the cabin 22 as mentioned above. And, is in communication with/under the control of the electronic control unit 20 as indicated by dashed line. Data collected and information generated by the electronic control unit 20 is output to the display 24 for use by a driver of the vehicle 10. As explained in greater detail below, this data and information, among other things, can inform the driver about a state of the CNG system.

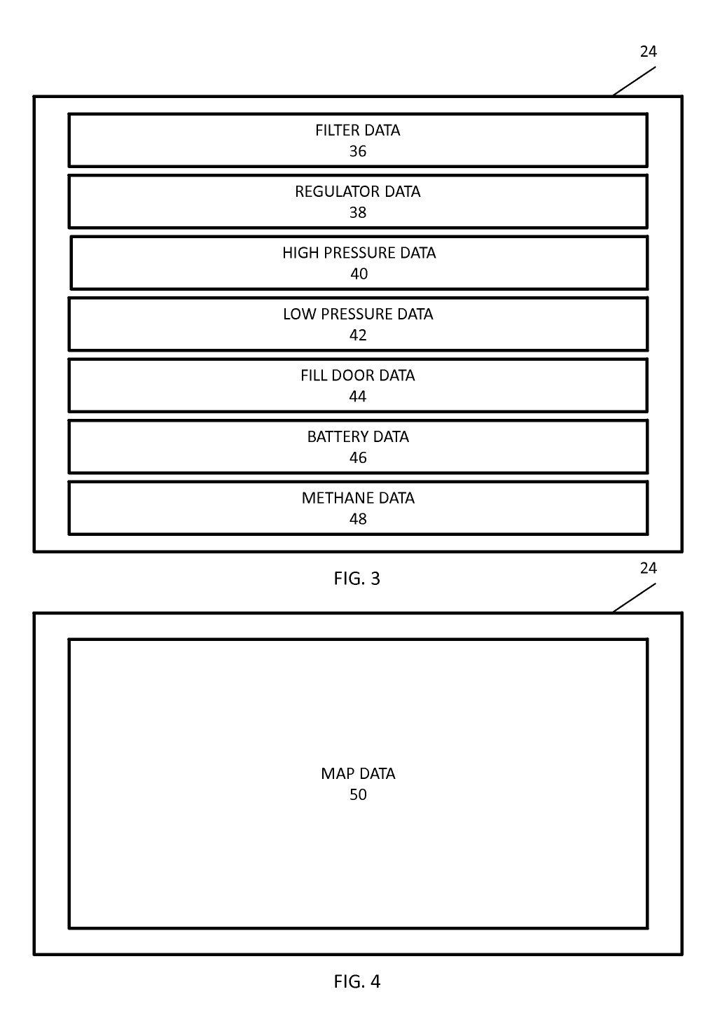

Referring to FIG. 2, the display 24 is configured with graphics relating to the CNG system. A fuel graphic 26, pressure graphic 28, gallons to empty graphic 30, methane level graphic 32, and filter life graphic 34 visually convey information about the CNG in the reservoir 14 as well as conditions of equipment associated therewith. The graphics 26, 28, 30, in this example, are digital dials that indicate respectively percentage of CNG in the reservoir 14, pressure within the reservoir 14, and diesel gallon equivalents within the reservoir 14. The graphics 32, 34 are digital gauges that indicate respectively methane level associated with the CNG system and a remaining life of the filter in the fluid path between the reservoir 14 and engine 12. The graphical user interface of the display 24 may of course take on other configurations.

Referring again to FIG. 1, the electronic control unit 20 implements algorithms to determine, among other things, diesel gallon equivalents associated with the reservoir 14 based on data collected by the sensors 16, 18. These algorithms, in the following example, are embedded in the Ruby programming language (any suitable technique, however, may be used):

100 class CNG
102 PressurePerTempF = (33.0/180)/100
104 PressureAtSeaLevel = 14.69
106 PressureAt5000Feet = 12.22
108 PressureChangePerFoot = ((PressureAtSeaLevel − PressureAt5000Feet)/5000)
110 MinimumUsablePSI = 200
112 MaxDGE = 80
114 class << self
116 def psi_at_sea_level_60F(psi, temperature, elevation = 5000)
118 t_adj = psi * ((temperature− 60) * PressurePerTempF)
120 a_adj = PressureChangePerFoot * elevation
122 psi − (t_adj + a_adj)
124 end
126 def percentage_full(current_adjusted_psi)
128 (current_adjusted_psi/3600.0)*100
130 end
132 def dge_to_gge(dge)
134 dge/0.88
136 end
138 def current_dge(percentage)
140 MaxDGE * (percentage/100.0)
142 end
144 def miles_til_empty(percentage, mpp)
146 mpp * percentage
148 end
150 end
152 end
154 puts
“AdjustedPSI:#{CNG.psi_at_sea_level_60F(1600, 61)}”
156 puts “PercentFull:#{CNG.percentage_full(CNG.psi_at_sea_level_60F(1600-200,
61))}”
158 puts
“DGERemaining:#{CNG.current_dge(CNG.percentage_full(CNG.psi_at_sea_level_60F(1600-200,
61)))}”
160 puts
“MilesTilEmpty:#{CNG.miles_til_empty(CNG.percentage_full(CNG.psi_at_sea_level_60F(1600-
200, 61))

The values initialized at lines 110 and 112 are based on the particular type of CNG system, and can vary from system to system. (DGE and dge both stand for diesel gallon equivalents.) The “temperature” variable of lines 116 and 118 is read from the temperature senor 16. That is, it is the temperature of the CNG. The “elevation” variable of lines 116 and 118 is read from the altitude senor 18. The variable “current_adjusted_psi” of lines 126 and 128 can take on values that result from executing line 122. The variable “dge” of lines 132 and 134 can take on values that result from executing line 140. The variable “percentage” of lines 138, 140, 144 and 146 can take on values that result from executing line 128. The variable “mpp” stands for miles per percentage and is determined based on test data indicating the number of miles travelled for each drop in percentage point.

Referring to FIG. 3, the display 24 is again configured with graphics relating to the CNG system. A filter data graphic 36, regulator data graphic 38, high-pressure data graphic 40, low pressure data graphic 42, fill door data graphic 44, battery data graphic 46, and methane data graphic 48 visually convey information about the CNG system and vehicle 10. The graphics 36 through 48 may be digital indicators, numerical values, etc.

Referring to FIG. 4, the display 24 is configured with graphics relating to a location of the vehicle 10. Global positioning data collected by one of the sensors 18 may be interpreted by the electronic control unit 20 so that map data 50 including the location of the vehicle 10 and/or points of interest, such as locations of CNG refueling stations, can be presented to the driver.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A compressed natural gas (CNG) fueling system comprising:
a CNG reservoir configured to be mounted to a vehicle;
a sensor arrangement configured to sense an environmental condition in a vicinity of the vehicle and a condition associated with the reservoir;
an electronically configurable display configured to be mounted within a cabin of the vehicle; and
an electronic control unit operatively arranged with the sensor arrangement and display, and configured to generate output for the display based on the sensed conditions to provide information about the CNG fueling system.

2. The system of claim 1, wherein the output is indicative of an amount of CNG in the reservoir.

3. The system of claim 1, wherein the output is indicative of a pressure within the reservoir.

4. The system of claim 1, wherein the output is indicative of an amount of methane associated with the reservoir.

5. The system of claim 1 further comprising a regulator and wherein the output is indicative of a status of the regulator.

6. The system of claim 1, wherein the electronic control unit is further configured receive data from a network of the vehicle and to generate output for the display further based on the data.

8. The system of claim 1 further comprising a wireless transceiver in communication with the electronic control unit, wherein the electronic control unit is further configured to transmit data associated with the output via the wireless transceiver.
